(19) United States
(12) Patent Application Publication
(10) Pub. No.: US 2009/0102830 A1
(43) Pub. Date: Apr. 23, 2009

(54) DISPLAY APPARATUS AND METHOD FOR COMPENSATING BEAM TILT

(75) Inventor: In-Jae YEO, Yongin-si (KR)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: SAMSUNG ELECTRO-MECHANICS CO., LTD., Suwon (KR)

(21) Appl. No.: 12/251,681

(22) Filed: Oct. 15, 2008

(30) Foreign Application Priority Data
Oct. 18, 2007 (KR) 10-2007-0104871

(51) Int. Cl. G09G 5/00; G02B 26/10

(52) U.S. Cl. 345/214

(57) ABSTRACT

Disclosed is a display apparatus compensating the tilt discrepancy of a light beam irradiated on a one-dimensional diffraction type optical modulator. The display apparatus corresponds to a 1-panel display apparatus that includes: a plurality of monochromatic light sources irradiating illumination light beams having different wavelengths; an optical modulator sequentially receiving the illumination light beams and modulating the illumination light beams according to a control signal; a scanner sequentially scanning the modulated illumination light beams on a display screen; and a control unit receiving an image signal and outputting a control signal controlling the monochromatic light source, the optical modulator and the scanner in accordance with the image signal. The control unit controls a pixel drive signal of the optical modulator such that a tilt of a monochromatic scanned image, in which the modulated illumination light beams is scanned on the display screen, is compensated.

### CROSS-REFERENCE TO RELATED APPLICATIONS

This application claims the benefit of Korean Patent Application No. 10-2007-0104871, filed with the Korean Intellectual Property Office on Oct. 18, 2007, the disclosure of which is incorporated herein by reference in its entirety.

### BACKGROUND

1. Technical Field

The present invention relates to a display device, more particularly to a display apparatus including one-dimensional diffraction type optical modulator and compensating the discrepancy of a beam tilt of an illumination light beam.

2. Description of the Related Art

Generally, an optical signal processing has advantages of a high speed, parallel processing ability and high-capacity information processing in contrast to conventional digital information processing incapable of processing a large amount of data in real time. In addition, research has been devoted to application of the optical signal processing to a design and manufacture of a binary phase filter, an optical logic gate, an optical amplifier, an optical element and an optical modulator. The optical modulator is used in fields such as an optical memory, an optical display, a printer, an optical interconnection and a hologram and the like, and research and development have been devoted to an optical beam scanning apparatus using the optical modulator.

Such an optical beam scanning apparatus in an image forming apparatus, for example, a laser printer, an LED printer, an electronic picture copy machine, a word processor and a projector and the like, scans an optical beam and then spots the optical beam on a photosensitive medium and performs a function of forming an image.

As a projection TV, etc. have been recently developed, the optical beam scanning apparatus is used as a means for scanning a beam onto an image display.

A one-dimensional diffraction type optical modulator used in a scanning display apparatus, i.e., a kind of a display apparatus is formed of a plurality of micro-mirrors arranged in a line and outputs a modulated light beam corresponding to a linear image. In this case, in order to represent a light intensity of a pixel, micro-mirrors change their displacements in response to a driving signal (i.e., a driving voltage), so that a quantity of the modulated light beam is changed. Such a modulated light beam is scanned on a screen through a scanner, and then two-dimensional or three-dimensional display image is formed.

That is, illumination light beam is irradiated in the form of a line beam on the one-dimensional diffraction type optical modulator from the light source. An illumination light beam according to each color is irradiated for the purpose of forming a color display image. When positions of the one-dimensional diffraction type optical modulator, on which the illumination light beams incident do not agree with each other in accordance with their colors, in other words, when there is an error in beam tilt, tilted display images are finally formed onto different positions of the screen according to their colors.

An acceptable error of the discrepancy of the beam tilt in the optical modulator is ordinarily not equal to and less than 1/(vertical resolution) radian. Accordingly, illumination light beams from a monochromatic light source should be very precisely discrepant with each other when an optical module is assembled, which is a very difficult process. When the beam tilt of the illumination light beam from the monochromatic light source occurs, assembled finished products have defectiveness so that failure cost is increased, high precision of assembly equipments is required and assembling time is increased.

### SUMMARY

The present invention provides a method for compensating the discrepancy of a beam tilt of a monochromatic light source and a display apparatus applying the same.

An aspect of the present invention features a 1-panel display apparatus. The 1-panel display apparatus in accordance with an embodiment of the present invention can include: a plurality of monochromatic light sources, configured to irradiate illumination light beams having different wavelengths; an optical modulator, configured to sequentially receive the illumination light beams and modulate the illumination light beams according to a control signal; a scanner, configured to sequentially scan the modulated illumination light beams on a display screen; and a control unit, configured to receive an image signal and output a control signal controlling the monochromatic light source, the optical modulator and the scanner in accordance with the image signal, wherein the control unit controls a pixel drive signal of the optical modulator such that a tilt of a monochromatic scanned image is compensated, the monochromatic scanned image being the modulated illumination light beams having been scanned on the display screen.

The scanner can rotate unidirectionally or bidirectionally.

The scanning direction is left to right, and the control unit controls an uppermost pixel of the optical modulator to be first outputted and the output to be linearly delayed from an upper end to a lower end if the monochromatic scanned image is tilted clockwise, and the control unit controls a lowest pixel of the optical modulator to be first outputted and the output to be linearly delayed from the lower end to the upper end if the monochromatic scanned image is tilted counter-clockwise. The output delay is determined in accordance with a degree of tilt of the monochromatic scanned image.

The scanning direction is right to left, and the control unit controls an uppermost pixel of the optical modulator to be first outputted and the output to be linearly delayed from an upper end to a lower end if the monochromatic scanned image is tilted counter-clockwise, and the control unit controls a lowest pixel of the optical modulator to be first outputted and the output to be linearly delayed from the lower end to the upper end if the monochromatic scanned image is tilted clockwise. The output delay is determined in accordance with a degree of tilt of the monochromatic scanned image.

Another aspect of the present invention features a multi-panel display apparatus. The multi-panel display apparatus in accordance with an embodiment of the present invention can include: a plurality of monochromatic light sources, configured to irradiate illumination light beams having different wavelengths; a plurality of optical modulators, configured to receive the illumination light beams and modulate the illumination light beams according to a control signal; a color synthesis optical system, configured to synthesize the modulated illumination light beams; a scanner, configured to scan a light beam synthesized by the color synthesis optical system on a display screen; and a control unit, configured to receive an image signal and output a control signal controlling the plurality of monochromatic light sources, the plurality of optical modulators and the scanner in accordance with the image signal, wherein the control unit controls a pixel drive signal of the optical modulator such that a tilt of a monochromatic scanned image is compensated, the monochromatic scanned image being the modulated illumination light beams having been scanned on the display screen.

Yet another aspect of the present invention features a method of compensating a beam tilt in a display apparatus in which an illumination light beam is scanned on a display screen, the illumination light beam being sequentially irradiated by a plurality of monochromatic light sources and being modulated by an optical modulator. The method in accordance with an embodiment of the present invention can include: determining a degree of tilt of a monochromatic scanned image formed on the display screen; and determining an outputting timing per pixel of the monochromatic scanned image based on the degree of tilt and a scanning direction of the monochromatic scanned image.

In the step of determining the outputting timing, the scanning direction is left to right, and an uppermost pixel of the optical modulator is controlled to be first outputted and the output is controlled to be linearly delayed from an upper end to a lower end if the monochromatic scanned image is tilted in clockwise, and a lowest pixel of the optical modulator is controlled to be first outputted and the output is controlled to be linearly delayed from the lower end to the upper end if the monochromatic scanned image is tilted counter-clockwise.

In the step of determining the outputting timing, the scanning direction is right to left, and an uppermost pixel of the optical modulator is controlled to be first outputted and the output is controlled to be linearly delayed from an upper end to a lower end if the monochromatic scanned image is tilted in the counter-clockwise direction, and a lowest pixel of the optical modulator is controlled to be first outputted and the output is controlled to be linearly delayed from the lower end to the upper end if the monochromatic scanned image is tilted in the clockwise direction.

Meanwhile, a method of compensating a beam tilt can be executed by a computer and can be recorded on a computer-readable recorded medium configured to record a program to be executed by the computer.

Another aspect as well as the description mentioned above, a characteristic, an advantage will be clear with the following drawings, claims and detailed description of the present invention.

### BRIEF DESCRIPTION OF THE DRAWINGS

FIG. 1 illustrates a configuration of 1-panel display apparatus according to an embodiment of the present invention.

FIG. 2 illustrates a solid perspective view showing an optical modulator including a plurality of micro-mirrors.

FIG. 3 illustrates a plan view showing an optical modulator including a plurality of micro-mirrors illustrated in FIG. 2.

FIG. 4 illustrates the discrepancy of beam tilts of illumination light beams incident on an optical modulator.

FIG. 5 illustrates an image distortion caused by the discrepancy of the beam tilt of an illumination light beam in accordance with its color.

FIG. 6 illustrates a configuration of a display apparatus having the discrepancy of the beam tilt of each illumination light beam in accordance with its color.

FIG. 7 illustrates a block diagram showing a control unit of a 1-panel display apparatus according to an embodiment of the present invention.

FIG. 8 illustrates a pixel drive signal and a tilt timing signal according to a drive angle of a scanner at the time of the unidirectional scanning in a 1-panel display apparatus according to an embodiment of the present invention.

FIG. 9 illustrates a pixel drive signal and a tilt timing signal according to a drive angle of a scanner at the time of the bidirectional scanning in a 1-panel display apparatus according to an embodiment of the present invention.

FIG. 10 illustrates a method for compensating a tilt of a linear image tilted by angle of θₜᵢₗₜ in the clockwise direction when a linear image is scanned from left to right.

FIG. 11 illustrates a method for compensating a tilt of a linear image tilted by angle of θₜᵢₗₜ in the counter-clockwise direction when a linear image is scanned from left to right.

FIG. 12 illustrates a configuration of a 3-panel display apparatus according to another embodiment of the present invention.

FIG. 13 illustrates an example of the beam tilt of a 3-panel display apparatus according to another embodiment of the present invention.

FIG. 14 illustrates an image distortion caused by the discrepancy of the tilt of a linear image in accordance with its color.

FIG. 15 illustrates a configuration of a display apparatus having the discrepancy of the tilt of a linear image in accordance with its color.

FIG. 16 illustrates a block diagram showing a control unit of a 3-panel display apparatus according to another embodiment of the present invention.

FIG. 17 illustrates a pixel drive signal and a tilt timing signal according to a drive angle of a scanner at the time of the unidirectional scanning in a 3-panel display apparatus according to an embodiment of the present invention.

FIG. 18 illustrates a pixel drive signal and a tilt timing signal according to a drive angle of a scanner at the time of the bidirectional scanning in a 3-panel display apparatus according to another embodiment of the present invention.

### DETAILED DESCRIPTION

Since there can be a variety of permutations and embodiments of the present invention, certain embodiments will be illustrated and described with reference to the accompanying drawings. This, however, is by no means to restrict the present invention to certain embodiments, and shall be construed as including all permutations, equivalents and substitutes covered by the spirit and scope of the present invention. In the following description of the present invention, the detailed description of known technologies incorporated herein will be omitted when it may make the subject matter unclear.

Terms such as “first” and “second” can be used in describing various elements, but the above elements shall not be restricted to the above terms. The above terms are used only to distinguish one element from the other.

The terms used in the description are intended to describe certain embodiments only, and shall by no means restrict the present invention. Unless clearly used otherwise, expressions in the singular number include a plural meaning. In the present description, an expression such as “comprising” or “consisting of” is intended to designate a characteristic, a number, a step, an operation, an element, a part or combinations thereof, and shall not be construed to preclude any presence or possibility of one or more other characteristics, numbers, steps, operations, elements, parts or combinations thereof.

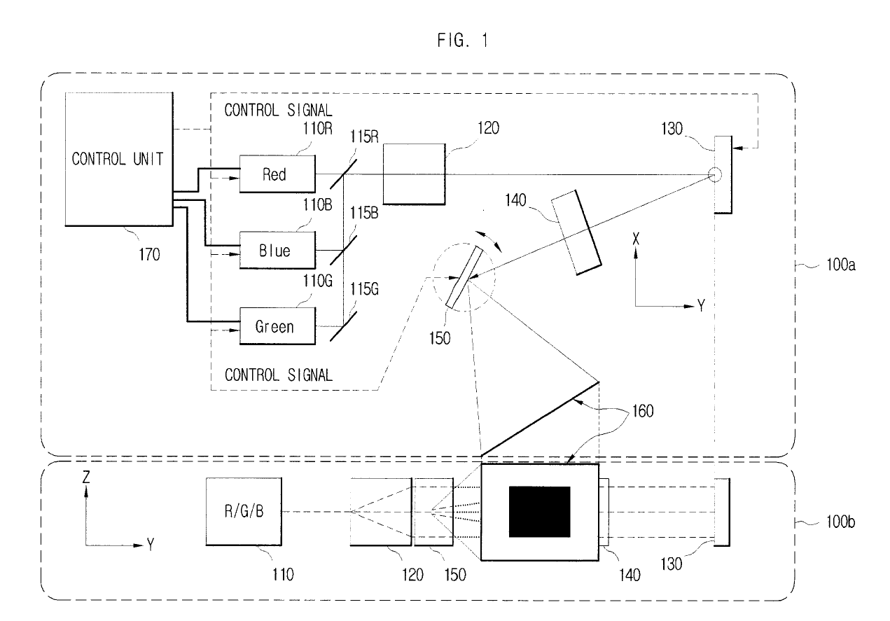

FIG. 1 illustrates a configuration of a 1-panel display apparatus according to an embodiment of the present invention. An X-Y plan view 100A of the 1-panel display apparatus and a Y-Z plan view 100B of the 1-panel display apparatus are illustrated. A light source 110 (a red light source 110R, a green light source 110G, a blue light source 110B, mirror 115G, a first dichroic mirror 115R, a second dichroic mirror 115B, an illumination optical system 120, an optical modulator 130, an imaging optical system 140, a scanner 150, a display screen 160 and a control unit 170 are illustrated as well. Here, the panel refers to the optical modulator 130 modulating an illumination light beam. Since the number of the optical modulator 130 is one, the display apparatus corresponds to the 1-panel display apparatus.

The light source 110 irradiates a beam of light. The light source 110 can be a laser, an LED, a laser diode and the like.

According to an embodiment, the light source 110 irradiates a white light beam. In this case, a color separating unit (not shown) is provided to separate the white light beam into a red light beam, a green light beam and a blue light beam in accordance with a predetermined condition.

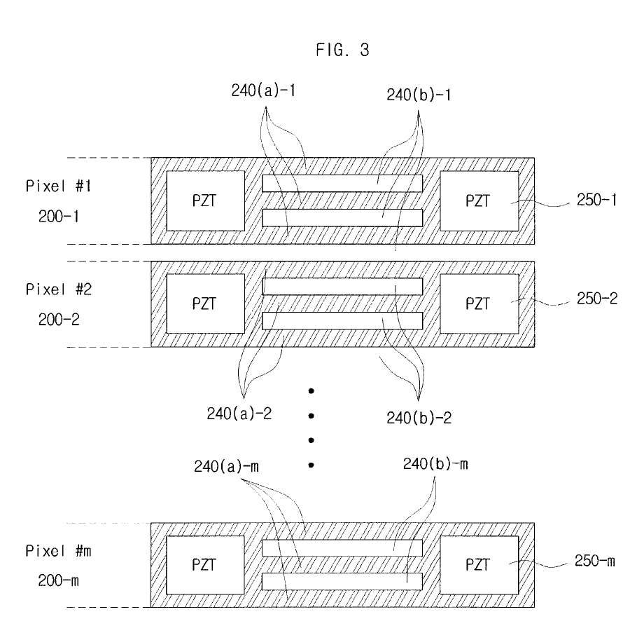

According to another embodiment, the light source 110 is, as illustrated in FIG. 3, separated into a red light source 110R, a blue light source 110B and a green light source 110G, so that three primary colors, i.e., a red light beam, a blue light beam and a green light beam are irradiated by the light source 110. Here, the red color, the green color and the blue color are no more than an embodiment. If various colors can be expressed through combination of color lights, a combination of other color lights is possible.

The illumination light system 120 is located between the light source 110 and the optical modulator 130. The illumination light system 120 adjusts a direction of a beam of light irradiated by the light source 110 and causes the beam of light to be focused on the optical modulator 130.

When the light source 110 is, as illustrated, formed of the red light source 110R, the blue light source 110B and the green light source 110G, both a mirror 115G for changing an optical path and dichroic mirrors 115R and 115B that reflect a light beam having a specified wavelength and transmit light beams having other wavelengths are provided in order that the illumination light beam irradiated by the each monochromatic light source can be input to the illumination optical system 120 along the same optical path.

The mirror 115G illustrated in FIG. 1 reflects the green light beam at a predetermined angle. The first dichroic mirror 115R transmits the red light beam and reflects the blue light beam and the green light beam at a predetermined angle. The second dichroic mirror 115B transmits the green light beam and reflects the blue light beam at a predetermined angle. Characteristics of the mirrors and the dichroic mirrors can be changed according to the structure in which the monochromatic light sources are arranged.

The optical modulator 130 modulates the illumination light beam irradiated by the light source 110 and outputs the modulated light beam in accordance with the control signal from the control unit 170. The optical modulator 130 is formed of a plurality of micro-mirrors arranged in parallel, which correspond to linear image corresponding to a vertical line or a horizontal line in frame of an image formed on the display screen 160. That is, the optical modulator 130 changes the displacement of each micro-mirror corresponding to each pixel of the linear image in accordance with the control signal, so that optical modulator outputs the modulated light beam in which each pixel has various quantities of light.

The number of the micro-mirrors is more than the number of pixels forming the linear image. One micro-mirror can represent one pixel or a plurality of adjacent micro-mirrors can represent one pixel. The modulated light beam is a line beam reflecting image information (that is, a luminance value of each pixel forming the linear image) of the linear image to be later formed on the display screen 160, and can be a 0^{th} order diffracted light, +N^{th} order diffracted light or −N^{th} order diffracted light, N being a natural number.

A drive circuit is further included so that a driving signal (for example, a driving voltage or a driving current, etc.) corresponding to the control signal of the control unit 170 is provided to each micro-mirror of the optical modulator 130 in such a manner that the displacement can be changed.

The modulated light beam from the optical modulator 130 is input to the scanner 150 via the imaging optical system 140. The imaging optical system 140 can include one or more lenses and transmits the modulated light beam by adjusting magnification according to a ratio of the size of the optical modulator 130 to the size of the scanner 150. Additionally, the imaging optical system 140 receives one of the diffracted light beams of a plurality of diffraction orders, which are outputted from the optical modulator 130.

The scanner 150 reflects the modulated light beam corresponding to the linear image and projects the modulated light beam on the display screen 160. The scanner 150 rotates according to the control signal from the control unit 170, reflects the modulated light beam according to time and changes the position where the modulated light beam is projected on the display screen 160, such that a plurality of linear images are projected and one two-dimensional image or one three-dimensional image is displayed as a whole. The scanner 150 can be a polygon mirror rotating unidirectionally, a rotating bar rotating unidirectionally or a galvano mirror rotating bidirectionally, etc.

The control unit 170 generates and outputs a control signal for controlling the light source 110, the optical modulator 130, and the scanner 150 in accordance with the input image information. The control unit classifies two-dimensional image information or three-dimensional image information as information about a plurality of linear images and controls the drive angle of the scanner 150 with respect to information about each linear image so that light which has been modulated by the optical modulator 130 is projected on the position corresponding to a corresponding linear image on the display screen 160.

The optical modulator 130 applied to the present invention will be described below. The optical modulator 130 modulates a beam of light by using a method of controlling on/off of light or a method of using a reflection/diffraction. The method of using a reflection/diffraction can be classified into an electrostatic method and a piezoelectric method. The optical modulator will be described focusing on the piezoelectric method in the following description. However, the electrostatic method is also applicable in the same way.

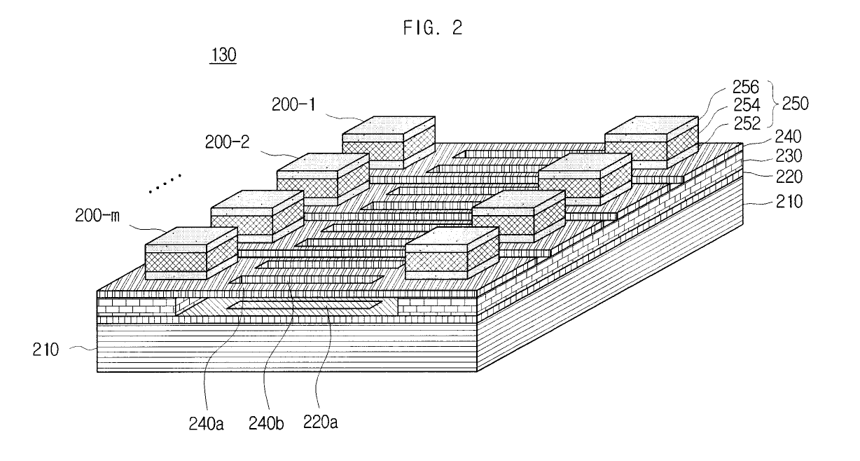

A micro-mirror included in an open-hole structural optical modulator is illustrated in FIG. 2 and FIG. 3. FIG. 2 illustrates a solid perspective view of an optical modulator including a plurality of micro-mirrors. FIG. 3 illustrates a plan view of an optical modulator including a plurality of the micro-mirrors illustrated in FIG. 2. In this embodiment, it is assumed that one micro-mirror is responsible for one pixel.

A plurality of micro-mirrors 200-1, 200-2, . . . 200-m (hereinafter, commonly designated as 200) are arranged in a line. Each micro-mirror includes a substrate 210, an insulation layer 220, a sacrifice layer 230, a ribbon structure 240 and a piezoelectric substance 250.

The insulation layer 220 is laminated on the substrate 210. The sacrifice layer 230 separates the ribbon structure 240 from the insulation layer 220 as long as a certain gap. The ribbon structure 240 interferes with an incident illumination light beam and optically modulates a signal. The ribbon structure 240 can have a plurality of open-holes 240B in its central part. While the open-hole 240B having a long rectangular shape in the direction of the length of the micro-mirror 200 is illustrated, various shapes such as a circular shape, an elliptic shape, etc. can be applied to the open-hole 240B. Additionally, a large number of the long rectangular shaped open-holes can be arranged in parallel with each other in the direction of the width of the micro-mirror 200.

The piezoelectric substance 250 is formed of a lower electrode 252, a piezoelectric layer 254 and an upper electrode 256, and controls the ribbon structure 240 to move up and down in accordance with the degree of the contraction or dilation in the direction of up and down or right and left, which is generated by voltage difference between the upper part electrode and the lower part electrode. The reflective layer 220A can be formed in correspondence to the hole 240B formed on the ribbon structure 240 or can be formed on the whole insulation layer.

For example, when the wavelength of a beam of light is λ, a first voltage is applied to the piezoelectric substance 250 in such a manner that a gap between the upper reflective layer 240A formed on the ribbon structure 240 and the lower reflective layer 220A formed on the insulation layer 220 can be (2l)λ/4, l being a natural number. At this time, in case of zero order diffracted light, a total path difference between the light reflected from the upper reflective layer 240A and the light reflected from the lower reflective layer 220A is equal to lλ, so that a constructive interference occurs. Accordingly, the modulated light has the maximum luminance (that is, the maximum quantity of light). In case of +1^{st} order and −1^{st} order diffracted lights, the beam of light has the minimum luminance (that is, the minimum quantity of light) through a destructive interference.

Also, a second voltage is applied to the piezoelectric substance 250 in such a manner that a gap between the upper reflective layer 240A formed on the ribbon structure 240 and the lower reflective layer 220A formed on the insulation layer 220 can be (2l+1)λ/4, 1 being a natural number. At this time, in case of zero order diffracted light, a total path difference between the light reflected from the upper reflective layer 240A and the light reflected from the lower reflective layer 220A is equal to (2l+1)λ/2, so that a destructive interference occurs. Accordingly, the modulated light has the minimum luminance (that is, the minimum quantity of light). In case of +1^{st} order and −1^{st} order diffracted lights, the light has the maximum luminance (that is, the maximum quantity of light) value through a constructive interference.

As a result of the interference mentioned above, the micro-mirror is able to load a signal of one pixel on the beam of light by adjusting the quantity of the diffracted light. A case where the gap between the ribbon structure 240 and the insulation layer 220 is either (2l)λ/4 or (2l+1)λ/4 has been described in the foregoing description. However, the luminance of light interfered by diffraction and reflection of the incident illumination light can be controlled through adjustment of the gap between the ribbon structure 240 and the insulation layer 220. Zero order diffracted light, +N^{th} order diffracted light, −N^{th} order diffracted light, etc., N being a natural number, correspond to the modulated light. The optical modulator 130 has an m number of micro-mirrors 200-1, 200-2, . . . , 200-m, which respectively are responsible for a pixel #1, a pixel #2, . . . , a pixel #m. The optical modulator 130 deals with information about the linear image of the vertical line (here, it is assumed that the vertical line is formed of m numbers of pixels, and each of micro-mirrors 200-1, 200-2, . . . , 200-m deals with one of m numbers of pixels constituting the vertical line. Accordingly, the light beam reflected and/or diffracted by each micro-mirror is then projected by the scanner 150 on the screen as a two-dimensional or three-dimensional image.

While an optical modulator having the open-hole structure in which the open-holes are provided so that one micro-mirror deals with one pixel has been described as illustrated in FIGS. 2 and 3, multiple micro-mirrors can deal with one pixel as well. In a micro-mirror without the open-hole, it is possible to use a reflected light path difference according to the difference between height of a micro-mirror of an even number and height of a micro-mirror of an odd number among a large number of micro-mirrors. In addition, it should be understood by those skilled in the art that optical modulators of various types are applicable to the present invention.

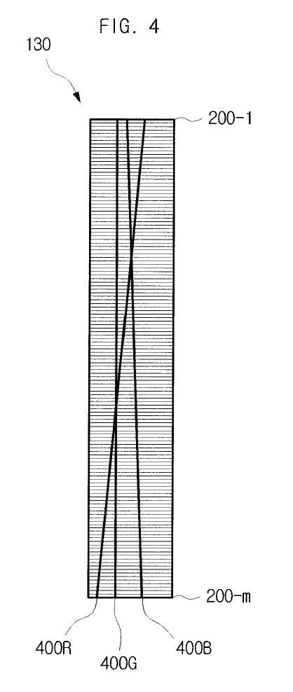

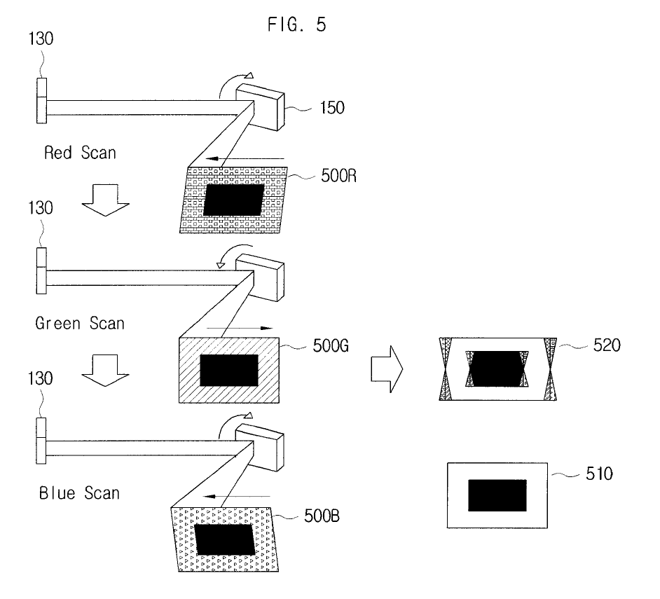

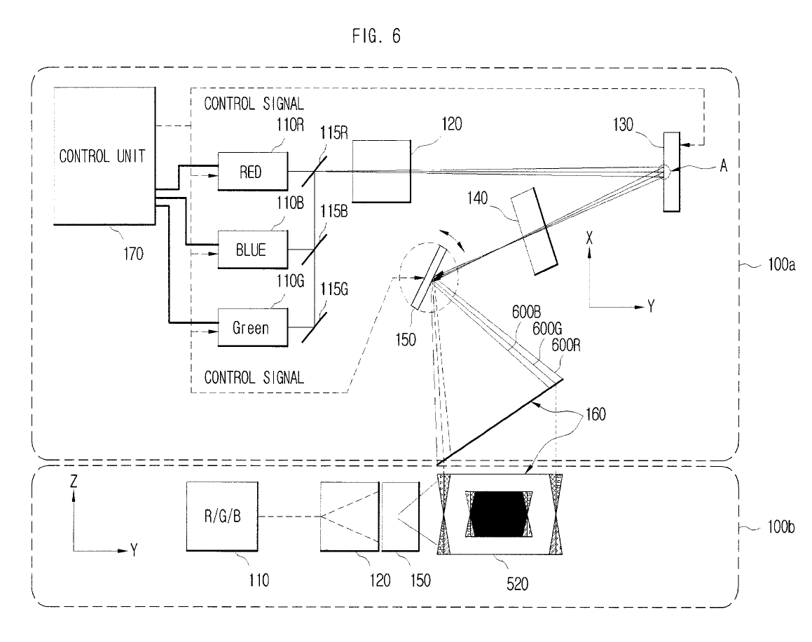

FIG. 4 illustrates the discrepancy of beam tilts of illumination light beams incident on an optical modulator. FIG. 5 illustrates an image distortion caused by the discrepancy of the beam tilt of an illumination light beam in accordance with its color. FIG. 6 illustrates a configuration of a display apparatus having the discrepancy of the beam tilt of each illumination light beam in accordance with its color.

M number of micro-mirrors from a first micro-mirror 200-1 to an m^{th} micro-mirror 200-m are arranged in the optical modulator 130 in parallel with each other. After a red light beam 400R, a green light beam 400G and a blue light beam 400B are incident on such an optical modulator 130, the beams are outputted as diffracted light beams having linear image information in accordance with drive of each micro-mirror as described above.

In this case, as illustrated in FIG. 4, illustrated in FIG. 5 is a result that the red light beam 400R, the green light beam 400G and the blue light beam 400B are incident on the optical modulator 130 such that there is a tilt error thereamong.

It is assumed that the illumination light beams are incident on the optical modulator 130 in order of a red light beam, a green light beam and a blue light beam in the present embodiment. A modulated red light beam outputted by the optical modulator 130 forms a red image 50OR through the scanner 150. A modulated green light beam being outputted by the optical modulator 130 forms a green image 500G through the scanner 150. A modulated blue light beam being outputted by the optical modulator 130 forms a blue image 500B through the scanner 150.

Here, because the beam tilts of the illumination light beams on the optical modulator 130 are different from each other, the red image 500R is tilted to the right and the blue image 500B is tilted to the left. Since only the green image 500G has no tilt error, the green image 500G has a normal tilt. For this reason, there is a problem that a distorted color image 520 is formed, as compared with a target color image 510 intended to be formed on the display screen 160.

Referring to FIG. 6, since at least one of the red light beam, the green light beam and the blue light beam has the beam tilt error at a point of “A” on the optical modulator, at least one of a red image 600R, a green image 600G and a blue image 600B is tilted on the middle of the path through which the beams are projected to the display screen 160 via the scanner 150, so that a distorted color image 520 is formed. While light beams are mechanically adjusted to have no beam tilt error from the light source 110 to the optical modulator 130 in the conventional time so as to solve such a problem, a control unit 170 is designed to solve the problem in a digital manner in the present invention.

In the present invention, the 1-panel display apparatus scans a one-dimensional linear image and forms a two or three dimensional image. It is assumed that the linear image is a vertical line and scanning is performed in the right and left directions, i.e., a direction perpendicular to the vertical line.

When an image being scanned from left to right is tilted in the clockwise direction, the upper end of the vertical line is first outputted, and then the lower end of the vertical line is later outputted by linearly delaying the output of each pixel in the direction of the lower end. When an image being scanned from left to right is tilted in the counter-clockwise direction, the lower end of the vertical line is first outputted, and then the upper end of the vertical line is later outputted by linearly delaying the output of each pixel in the direction of the upper end. The amount of the output delay is determined by the amount of the tilt.

Also, when an image being scanned from right to left is tilted in the clockwise direction, the lower end of the vertical line is first outputted, and then the upper end of the vertical line is later outputted by linearly delaying the output of each pixel in the direction of the upper end. When an image being scanned from right to left is tilted in the counter-clockwise direction, the upper end of the vertical line is first outputted, and then the lower end of the vertical line is later outputted by linearly delaying the output of each pixel in the direction of the lower end. The amount of the output delay is determined by the amount of the tilt.

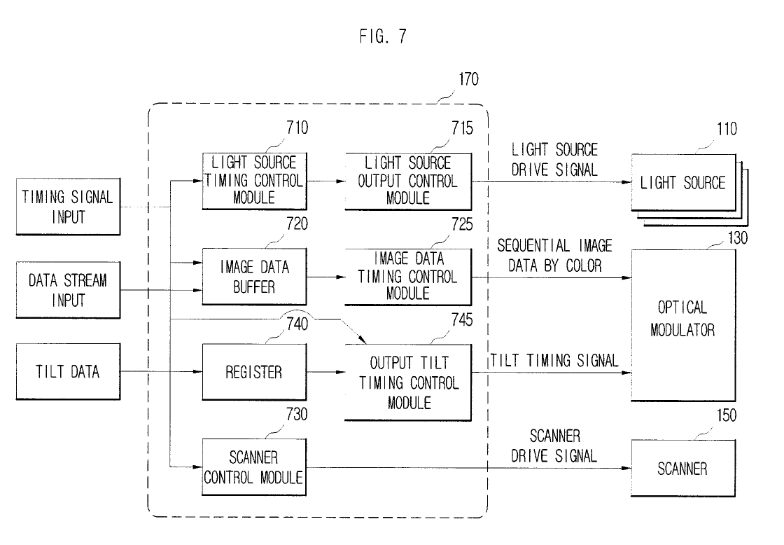

A configuration as described above for controlling the output timing of each pixel of the vertical line is illustrated in FIG. 7. FIG. 7 illustrates a block diagram showing a control unit 170 of a 1-panel display apparatus according to an embodiment of the present invention. Illustrated in FIG. 7 are the light source 110, the optical modulator 130, the scanner 150, a light source timing control module 710, a light source output control module 715, an image data buffer 720, an image data timing control module 725 and a scanner control module 730, a register 740 and an output tilt timing control module 745.

The control unit 170 receives a timing signal, data stream and tilt data. The timing signal includes information about light source timing, image data timing and scanner drive angle timing which can allow the input data stream to be normally displayed on the desired position of the display screen 160. The data stream includes image information about a color image frame intended to be formed on the display screen 160. Generally, data is input in order from a first horizontal line to a last horizontal line. The image data buffer 720 temporarily stores the image information about the input color image frames and outputs the image data stream by separating the image data stream according to the vertical line unit.

The light source timing control module 710 generates a light source timing signal for controlling on/off timing of each monochromatic light source in accordance with the input timing signal. The light source output control module 715 controls the output of each monochromatic light source. A light source drive signal includes such a light source timing signal and an output control signal.

The image data timing control module 725 controls the image data timing separated by the vertical line unit according to input timing signal, i.e., modulation timing of the optical modulator 130. In other words, sequential image data according to color is provided to the optical modulator 130. Here, it is preferable to synchronize the light source on/off timing with the image data timing. The scanner control module 730 controls the scanner 150 to have a predetermined drive angle and a drive speed and to rotate unidirectionally or bidirectionally in accordance with the input timing signal.

The tilt data is stored in the register 740. The output tilt timing control module 745 generates and outputs a tilt timing signal of a corresponding monochromatic scanned image through use of the tilt data stored in the register 740 and the input timing signal. The tilt timing signal, as described above, determines timing for driving each micro-mirror of the optical modulator 130 in consideration of a scanning direction and a tilt direction.

In the following description, methods for compensating a beam tilt at the time of both the unidirectional scanning and the bidirectional scanning will be described.

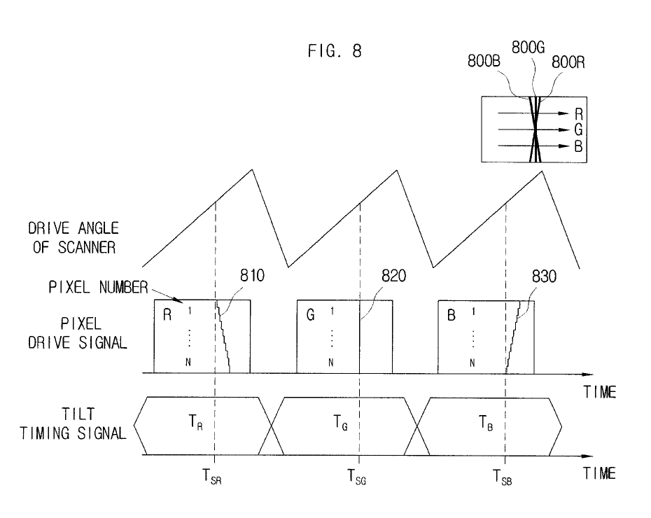

FIG. 8 illustrates a pixel drive signal and a tilt timing signal according to a drive angle of a scanner at the time of the unidirectional scanning in a 1-panel display apparatus according to an embodiment of the present invention. It is assumed that the scanning is performed from left to right, a red linear image 800R is tilted in the clockwise direction, and a blue linear image 800B is tilted in the counter-clockwise direction and a green linear image 800G is normal with no tilt. It is also assumed that the pixel number of the uppermost end of the optical modulator 130 is 1 and the pixel number of the lowest end of the optical modulator 130 is N. When there is no tilt within a tilt timing signal T_{R} of the red image, a standard timing of a predetermined linear image is T_{SR}. Since the red image is scanned from left to right and is tilted in the clockwise direction, the pixel drive signal 810 of a corresponding linear image causes a pixel having the pixel number of 1 to be first outputted and then, the output is linearly delayed from the upper end to the lower end, so that a pixel having the pixel number of N is finally outputted. The amount of the output delay is determined by the amount of the tilt of the red image.

When there is no tilt within a tilt timing signal T_{G} of the green image, a standard timing of a predetermined linear image is T_{SG}. Since the green image has no tilt, a pixel drive signal 820 of a corresponding linear image is outputted at the same timing from the pixel number of 1 to the pixel number of N.

When there is no tilt within a tilt timing signal T_{B} of the blue image, a standard timing of a predetermined linear image is T_{SB}. Since the blue image is scanned from left to right and is tilted in the counter-clockwise direction, a pixel drive signal 830 of a corresponding linear image, the pixel drive signal 830 of a corresponding linear image causes a pixel having the pixel number of N to be first outputted and then, the output is linearly delayed from the lower end to the upper end, so that a pixel having the pixel number of 1 is finally outputted. The amount of the output delay is determined by the amount of the tilt of the blue image.

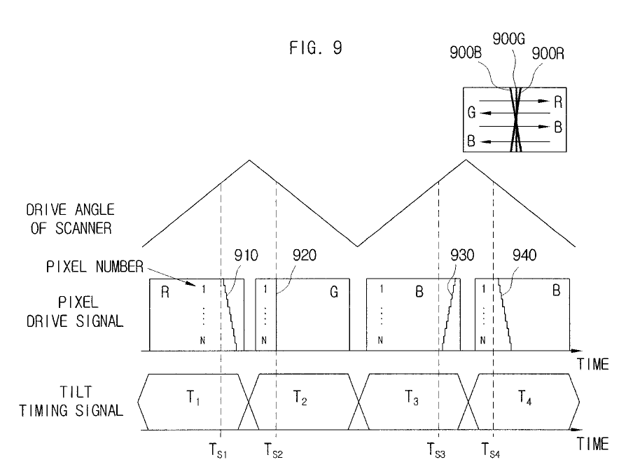

FIG. 9 illustrates a pixel drive signal and a tilt timing signal according to a drive angle of a scanner at the time of the bidirectional scanning in a 1-panel display apparatus according to an embodiment of the present invention.

It is assumed that the scanning is performed in order of left to right and right to left and in order of a red image, a green image, a blue image and a blue image. It is also assumed that a red linear image 900R is tilted in the clockwise direction, a blue linear image 900B is tilted in the counter-clockwise direction and a green linear image 900G is normal with no tilt. It is also assumed that the pixel number of the uppermost end of the optical modulator 130 is 1 and the pixel number of the lowest end of the optical modulator 130 is N.

First, the red image is scanned from left to right. When there is no tilt within a tilt timing signal T₁ of the red image, a standard timing of a predetermined linear image is T_{S1}. Since the red image is scanned from left to right and is tilted in the clockwise direction, the pixel drive signal 910 of a corresponding linear image causes a pixel having the pixel number of 1 to be first outputted and then, the output is linearly delayed from the upper end to the lower end, so that a pixel having the pixel number of N is finally outputted. The amount of the output delay is determined by the amount of the tilt of the red image.

The green image is scanned from right to left. When there is no tilt within a tilt timing signal T₂ of the green image, a standard timing of a predetermined linear image is T_{S2}. Since the green image has no tilt, a pixel drive signal 920 of a corresponding linear image is outputted at the same timing from the pixel number of 1 to the pixel number of N.

The blue image is scanned from left to right. When there is no tilt within a tilt timing signal T₃ of the blue image, a standard timing of a predetermined linear image is T_{S3}. Since the blue image is scanned from left to right and is tilted in the counter-clockwise direction, the pixel drive signal 930 of a corresponding linear image causes a pixel having the pixel number of N to be first outputted and then, the output is linearly delayed from the lower end to the upper end, so that a pixel having the pixel number of 1 is finally outputted. The amount of the output delay is determined by the amount of the tilt of the blue image.

The blue image is scanned from right to left again. When there is no tilt within a tilt timing signal T₄ of the blue image, a standard timing of a predetermined linear image is T_{S4}. Since the blue image is scanned from right to left and is tilted in the counter-clockwise direction, the pixel drive signal 940 of a corresponding linear image causes a pixel having the pixel number of 1 to be first outputted and then, the output is linearly delayed from the upper end to the lower end, so that a pixel having the pixel number of N is finally outputted. The amount of the output delay is determined by the amount of the tilt of the blue image. That is, for even the same monochromatic image, the pixel drive signal is changed according to the scanning direction.

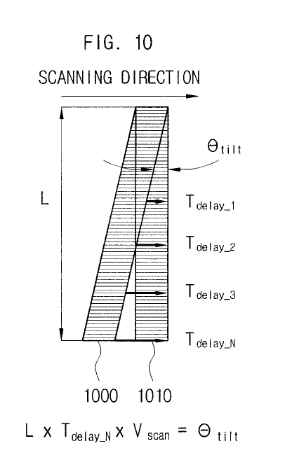

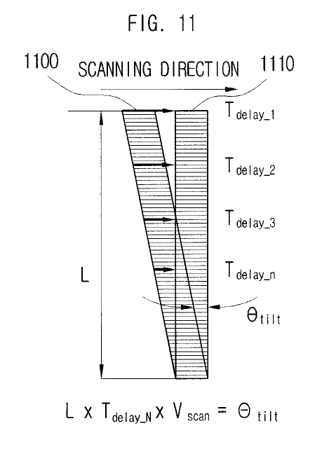

FIG. 10 illustrates a method for compensating a tilt of a linear image tilted by angle of θₜᵢₗₜ in the clockwise direction when a linear image is scanned from left to right. FIG. 11 illustrates a method for compensating a tilt of a linear image tilted by angle of θₜᵢₗₜ in the counter-clockwise direction when a linear image is scanned from left to right.

Referring to FIG. 10, an amount of a tilt is determined by a degree to which a linear image is tilted by a predetermined angle on the basis of a line perpendicular to a reference beam or a scanning direction, a linear image being displayed on the display screen 160 under the state of stopping a scanner 150.

Illustrated in FIG. 10 are a linear image 1000 before compensation and a linear image 1010 after compensation. An amount of the tilt θₜᵢₗₜ radian, i.e., a degree of tilt between the linear image 1000 before compensation and the linear image 1010 after compensation, satisfies the relation of the following equation (1).

θₜᵢₗₜ=L×T_{delay}_{_{—}}_{N}×Vscan (1),

where L represents a length of the linear image 1010 after compensation, T_{delay}_{_{—}}_{N} represents an output delay time from a first pixel to N^{th} pixel, and Vscan represents a scanning speed.

That is, when the amount of the tilt, the length of the linear image after compensation and the scanning speed are known, the output delay time of each pixel can be determined.

In the linear image 1000 before compensation, starting from the first pixel, an output is linearly delayed from the upper end to the lower end by the pixel drive signal corresponding to the output delay time determined by the equation (1), so that the linear image 1010 is displayed after the compensation in the direction perpendicular to the scanning direction.

Illustrated in FIG. 11 are a linear image 1100 before compensation and a linear image 1010 after compensation. An amount of the tilt θₜᵢₗₜ radian, i.e., a degree of tilt between the linear image 1000 before compensation and the linear image 1010 after compensation, satisfies the relation of the following equation (2).

θₜᵢₗₜ=L×T_{delay}_{_{—}}_{N}×Vscan (2),

where L represents a length of the linear image 1110 after compensation, T_{delay}_{_{—}}_{N} represents an output delay time from N^{th} pixel to a first pixel, and Vscan represents a scanning speed.

That is, when the amount of the tilt, the length of the linear image after compensation and the scanning speed are known, the output delay time of each pixel can be determined.

In the linear image 1100 before compensation, starting from the N^{th} pixel, an output is linearly delayed from the lower end to the upper end by the pixel drive signal corresponding to the output delay time determined by the equation (2), so that the linear image 1110 is displayed after the compensation in the direction perpendicular to the scanning direction.

While the method for compensating the beam tilt in the 1-panel display apparatus has been described in the foregoing, a method for compensating the beam tilt in a 3-panel display apparatus will be described in the following description.

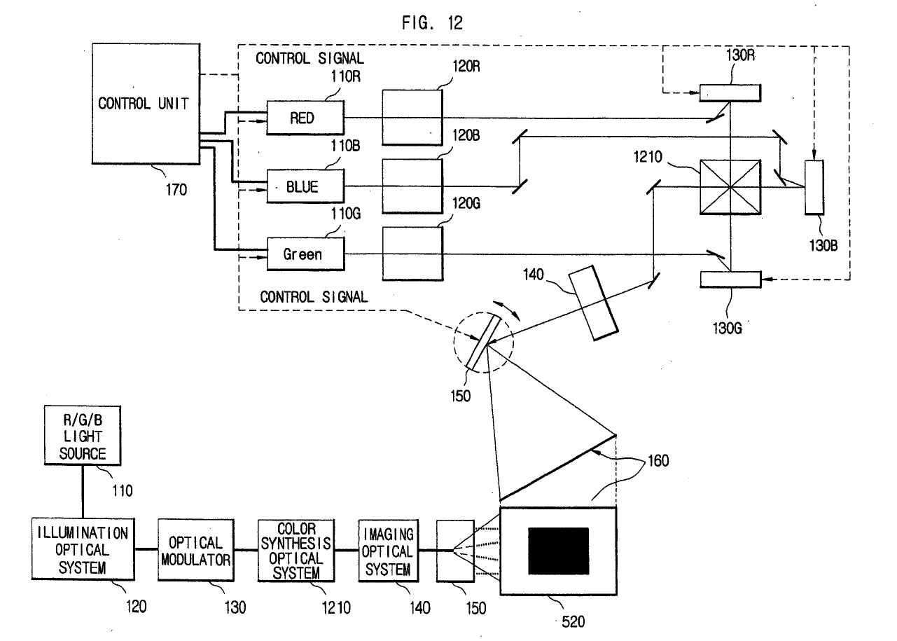

FIG. 12 illustrates a configuration of a 3-panel display apparatus according to another embodiment of the present invention.

FIG. 12 illustrates light sources 110 (a red light source 110R, a green light source 110G and a blue light source 110B), three illumination optical systems 120R, 120G and 120B, three optical modulators 130R, 130G and 130B, a color synthesis optical system 1210, an imaging optical system 140, a scanner 150, a display screen 160 and a control unit 170. Detailed description of elements performing the same/similar functions to the 1-panel display apparatus illustrated in FIG. 1 will be omitted for the sake of convenience of description and understanding of the present embodiment. The 3-panel display apparatus will be described focusing on the difference between the 1-panel display apparatus and the 3-panel display apparatus.

The 3-panel display apparatus includes three optical modulators 130R, 130G and 130B in contrast to the 1-panel display apparatus including one optical modulator 130. That is, the light source 110, the illumination optical system 120 and the optical modulator 130 are provided in accordance with each color.

The 1-panel display apparatus cannot represent image information about two or more colors at the same time. The 1-panel display apparatus sequentially represents a scanned image on the display screen one time with respect to the red light beam, the green light beam and the blue light beam so that color images can be formed on a time average.

In comparison, the 3-panel display apparatus can represent image information about three colors at the same time. The monochromatic light beams that have been modulated by the three optical modulators 130R, 130G and 130B are synthesized by the color synthesis optical system 1210 and are scanned on the display screen 160 through the imaging optical system 140 and the scanner 150.

When illumination light beams incident on optical modulators 130R, 130G and 130B are not correctly aligned in such a 3-panel display apparatus, the illumination light beams are not synthesized by the color synthesis optical system 1210 so that a color image being displayed is eventually distorted.

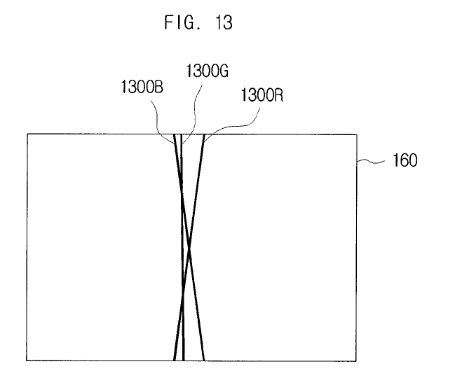

FIG. 13 illustrates an example of the beam tilt of a 3-panel display apparatus according to another embodiment of the present invention.

When the scanner 150 is stopped, a degree of tilt, i.e., both the tilt direction and the amount of the tilt according to each color can be obtained from a linear image displayed on the display screen 160. In this case, it can be understood that the green linear image 1300G has no tilt, the red linear image 1300R is tilted in the clockwise direction and the blue linear image 1300B is tilted in the counter-clockwise direction.

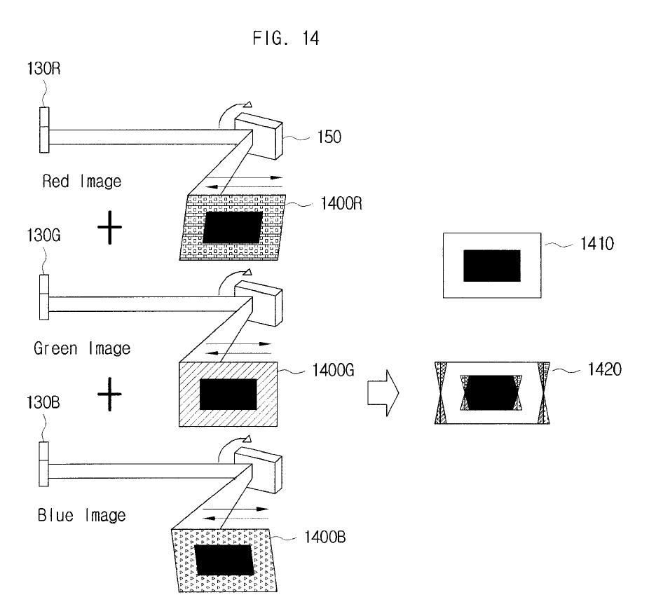

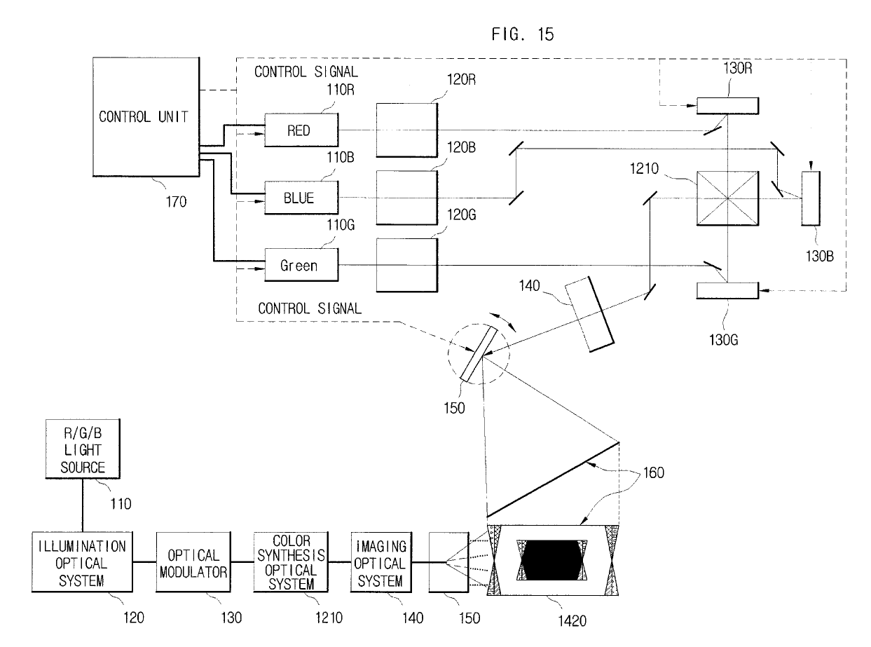

FIG. 14 illustrates an image distortion caused by the discrepancy of the tilt of a linear image in accordance with its color. FIG. 15 illustrates a configuration of a display apparatus having the discrepancy of the tilt of a linear image in accordance with its color.

In this case, illustrated in FIG. 14 is an image that is finally formed on the display screen 160 when there is, as illustrated in FIG. 13, a tilt error between two of the red linear image 1300R, the green linear image 1300G and the blue linear image 1300B.

A modulated red light beam being outputted by a first optical modulator 130R forms a red image 1400R tilted in the clockwise direction through the scanner 150. A modulated green light beam being outputted by a second optical modulator 130G forms a green image 1400G through the scanner 150. A modulated blue light beam being outputted by a third optical modulator 130B forms a blue image 1400B tilted in the counter-clockwise direction through the scanner 150. Since monochromatic images are tilted by different degrees, there is a problem that a distorted color image 1420 is formed as compared with a target color image 1410 intended to be formed on the display screen 160.

Referring to FIG. 15, at least one of a red image, a green image and a blue image is tilted on the middle of the path through which the beams are projected to the display screen 160 via the scanner 150, so that a distorted color image 1420 is formed. While light beams are mechanically adjusted to have no beam tilt error from the light source 110 to the optical modulator 130 in the conventional time so as to solve such a problem, a control unit 170 is designed to solve the problem in a digital manner in the present invention.

In the present invention, the 3-panel display apparatus scans a one-dimensional linear image and forms a two or three dimensional image. It is assumed that the linear image is a vertical line and scanning is performed in the right and left directions, i.e., a direction perpendicular to the vertical line.

When an image being scanned from left to right is tilted in the clockwise direction, the upper end of the vertical line is first outputted, and then the lower end of the vertical line is later outputted by linearly delaying the output of each pixel in the direction of the lower end. When an image being scanned from left to right is tilted in the counter-clockwise direction, the lower end of the vertical line is first outputted, and then the upper end of the vertical line is later outputted by linearly delaying the output of each pixel in the direction of the upper end. The amount of the output delay is determined by the amount of the tilt.

Also, when an image being scanned from right to left is tilted in the clockwise direction, the lower end of the vertical line is first outputted, and then the upper end of the vertical line is later outputted by linearly delaying the output of each pixel in the direction of the upper end. When an image being scanned from right to left is tilted in the counter-clockwise direction, the upper end of the vertical line is first outputted, and then the lower end of the vertical line is later outputted by linearly delaying the output of each pixel in the direction of the lower end. The amount of the output delay is determined by the amount of the tilt.

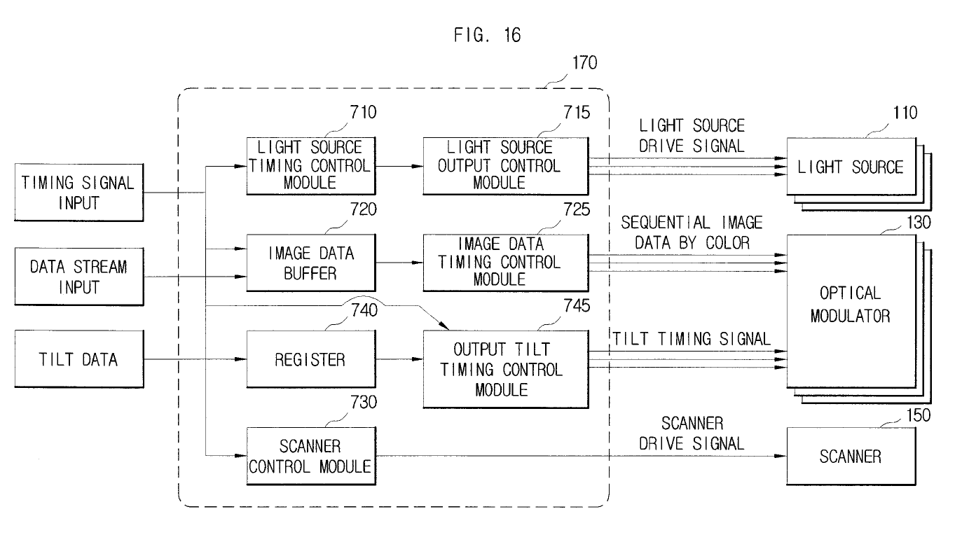

A configuration as described above for controlling the output timing of each pixel of the vertical line is illustrated in FIG. 16. FIG. 16 illustrates a block diagram showing a control unit 170 of a 3-panel display apparatus according to an embodiment of the present invention. The control unit 170 of the 3-panel display apparatus illustrated in FIG. 16 has the same function as that of the control unit 170 of the 1-panel display apparatus illustrated in FIG. 7. While a light source drive signal, sequential image data according to its color, and a tilt timing signal are sequentially provided in accordance with its color in the 1-panel display apparatus, there is a difference in that the light source drive signal, sequential image data according to its color, and the tilt timing signal are simultaneously provided for the three colors in the 3-panel display apparatus.

In the following description, methods for compensating a beam tilt at the time of both the unidirectional scanning and the bidirectional scanning will be described.

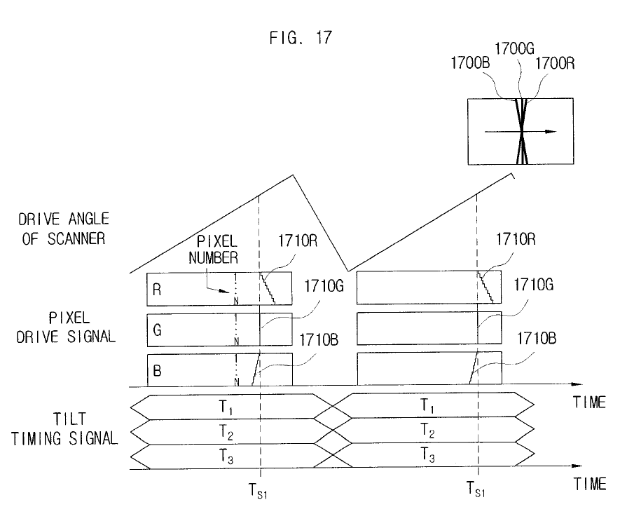

FIG. 17 illustrates a pixel drive signal and a tilt timing signal according to a drive angle of a scanner at the time of the unidirectional scanning in a 3-panel display apparatus according to an embodiment of the present invention.

It is assumed that a red image, a green image and a blue image are scanned from left to right at the same time, a red linear image 1700R is tilted in the clockwise direction, and a blue linear image 1700B is tilted in the counter-clockwise direction and a green linear image 1700G is normal with no tilt. It is also assumed that the pixel number of the uppermost end of each of the optical modulators 130R, 130G, 130B is 1 and the pixel number of the lowest end of the optical modulators 130R, 130G, 130B is N.

When there is no tilt within tilt timing signals T₁, T₂ and T₃ of the monochromatic image in the first frame, a standard timing of a predetermined linear image is T_{S1}. Since the red image is scanned from left to right and is tilted in the clockwise direction, the pixel drive signal 1710R of a corresponding linear image causes a pixel having the pixel number of 1 to be first outputted and then, the output is linearly delayed from the upper end to the lower end, so that a pixel having the pixel number of N is finally outputted. The amount of the output delay is determined by the amount of the tilt of the red image. Since the green image has no tilt, the pixel drive signal 1710G of a corresponding linear image causes pixels having the pixel number from 1 to N to be outputted at the same timing. Since the blue image is scanned from left to right and is tilted in the counter-clockwise direction, the pixel drive signal 1710B of a corresponding linear image causes a pixel having the pixel number of N to be first outputted and then, the output is linearly delayed from the lower end to the upper end, so that a pixel having the pixel number of 1 is finally outputted. The amount of the output delay is determined by the amount of the tilt of the blue image.

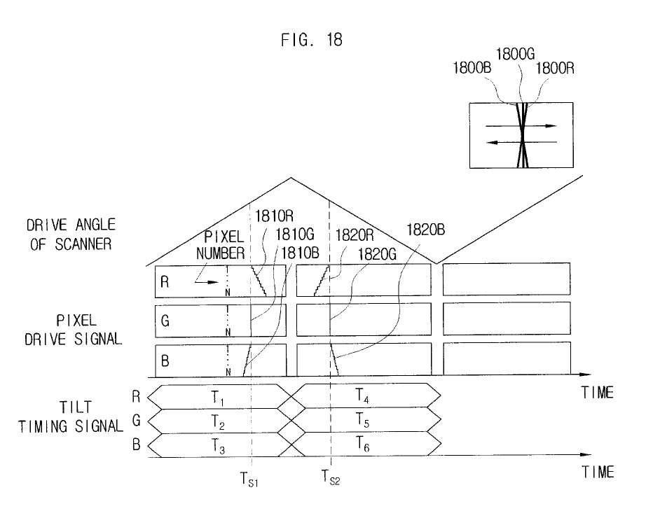

FIG. 18 illustrates a pixel drive signal and a tilt timing signal according to a drive angle of a scanner at the time of the bidirectional scanning in a 3-panel display apparatus according to another embodiment of the present invention.

It is assumed that the scanning is performed in order of left to right and right to left, and a red image, a green image and a blue image are simultaneously scanned. It is assumed that a red linear image 1800R is tilted in the clockwise direction, and a blue linear image 1800B is tilted in the counter-clockwise direction and a green linear image 1800G is normal with no tilt. It is also assumed that the pixel number of the uppermost end of each of the optical modulators 130R, 130G, 130B is 1 and the pixel number of the lowest end of the optical modulators 130R, 130G, 130B is N.

Scanning is performed from left to right in one image frame. When there is no tilt within tilt timing signals T₁, T₂ and T₃ of the monochromatic image, a standard timing of a predetermined linear image is T_{S1}. Since the red image is scanned from left to right and is tilted in the clockwise direction, the pixel drive signal 1810R of a corresponding linear image causes the pixel number of 1 to be first outputted and then, the output is linearly delayed from the upper end to the lower end, so that a pixel having the pixel number of N is finally outputted. The amount of the output delay is determined by the amount of the tilt of the red image. Since the green image has no tilt, the pixel drive signal 1810G of a corresponding linear image causes pixels having the pixel number from 1 to N to be outputted at the same timing. Since the blue image is scanned from left to right and is tilted in the counter-clockwise direction, the pixel drive signal 1810B of a corresponding linear image causes a pixel having the pixel number of N to be first outputted and then, the output is linearly delayed from the lower end to the upper end, so that a pixel having the pixel number of 1 is finally outputted. The amount of the output delay is determined by the amount of the tilt of the blue image.

Then, scanning is performed from right to left in the next image frame. When there is no tilt within tilt timing signals T₄, T₅ and T₆ of the monochromatic image, a standard timing of a predetermined linear image is T_{S2}. Since the red image is scanned from right to left and is tilted in the clockwise direction, the pixel drive signal 1820R of a corresponding linear image causes a pixel having the pixel number of N is first outputted and then, the output is linearly delayed from the lower end to the upper end, so that a pixel having the pixel number of 1 is finally outputted. The amount of the output delay is determined by the amount of the tilt of the red image. Since the green image has no tilt, the pixel drive signal 1820G of a corresponding linear image causes pixels having the pixel number from 1 to N to be outputted at the same timing. Since the blue image is scanned from right to left and is tilted in the counter-clockwise direction, the pixel drive signal 1820B of a corresponding linear image causes a pixel the pixel number of 1 to be first outputted and then, the output is linearly delayed from the upper end to the lower end, so that a pixel having the pixel number of N is finally outputted. The amount of the output delay is determined by the amount of the tilt of the blue image.

The output delay time according to a pixel of each linear image in the 3-panel display apparatus according to the embodiment of the present invention is obtainable through description illustrated in FIG. 10 or 11 and the foregoing equation (1) or (2). Since the matter mentioned above has been described in detail in the foregoing description, the descriptions thereof will be omitted.

The method for compensating the beam alignment in the 3-panel display apparatus has been described in the foregoing.

According to another embodiment of the present invention, it is possible to apply the above-mentioned method for compensating the beam alignment to a 2-panel display apparatus. In case of the 2-panel display apparatus, only the illumination light beam having one color is incident on one panel and an illumination light beam having the other two colors is incident on the other panel. Accordingly, it is possible to modify and apply the above-mentioned method for compensating the beam alignment in the 1-panel display apparatus to a panel on which the illumination light beam having two colors is incident, and possible to modify and apply the method for compensating the beam alignment in the 3-panel display apparatus to two panels.

Meanwhile, in the present invention, it is possible to compensate in such a manner that the positions of scanned images in accordance with each light beam of red, green and blue are respectively equal to the position of the scanned reference image because the position of the scanned reference image is preset on the display screen. On the other hand, on the basis of one of the red, green and blue light beams, it is also possible to compensate in such a manner that scanned images in accordance with the other light beams are equal to the scanned image in accordance with the reference light beam.

The above-described method for compensating the beam alignment can be implemented by computer programs. Program codes and code segments forming the programs can be easily inferred by computer programmers skilled in the art. The programs are stored in computer readable media and are read and executed by computers so that a method for providing a document-search service is implemented. The computer readable media includes a magnetic recording medium, an optical recording medium and a carrier wave medium.

While the present invention has been described focusing on exemplary embodiments thereof, it will be understood by those skilled in the art that various changes and modification in forms and details may be made without departing from the spirit and scope of the present invention as defined by the appended claims.

1. A 1-panel display apparatus comprising:
a plurality of monochromatic light sources, configured to irradiate illumination light beams having different wavelengths;
an optical modulator, configured to sequentially receive the illumination light beams and modulate the illumination light beams according to a control signal;
a scanner, configured to sequentially scan the modulated illumination light beams on a display screen; and
a control unit, configured to receive an image signal and output a control signal controlling the monochromatic light source, the optical modulator and the scanner in accordance with the image signal,
wherein the control unit controls a pixel drive signal of the optical modulator such that a tilt of a monochromatic scanned image is compensated, the monochromatic scanned image being the modulated illumination light beams having been scanned on the display screen.

2. The 1-panel display apparatus of claim 1, wherein the scanner rotates unidirectionally.

3. The 1-panel display apparatus of claim 1, wherein the scanner rotates bidirectionally.

4. The 1-panel display apparatus of claim 1, wherein the scanning direction is left to right, and the control unit controls an uppermost pixel of the optical modulator to be first outputted and the output to be linearly delayed from an upper end to a lower end if the monochromatic scanned image is tilted clockwise, and the control unit controls a lowest pixel of the optical modulator to be first outputted and the output to be linearly delayed from the lower end to the upper end if the monochromatic scanned image is tilted counter-clockwise.

5. The 1-panel display apparatus of claim 4, wherein the output delay is determined in accordance with a degree of tilt of the monochromatic scanned image.

6. The 1-panel display apparatus of claim 1, wherein the scanning direction is right to left, and the control unit controls an uppermost pixel of the optical modulator to be first outputted and the output to be linearly delayed from an upper end to a lower end if the monochromatic scanned image is tilted counter-clockwise, and the control unit controls a lowest pixel of the optical modulator to be first outputted and the output to be linearly delayed from the lower end to the upper end if the monochromatic scanned image is tilted clockwise.

7. The 1-panel display apparatus of claim 6, wherein the output delay is determined in accordance with a degree of tilt of the monochromatic scanned image.

8. A multi-panel display apparatus comprising:
a plurality of monochromatic light sources, configured to irradiate illumination light beams having different wavelengths;
a plurality of optical modulators, configured to receive the illumination light beams and modulate the illumination light beams according to a control signal;
a color synthesis optical system, configured to synthesize the modulated illumination light beams;
a scanner, configured to scan a light beam synthesized by the color synthesis optical system on a display screen; and
a control unit, configured to receive an image signal and output a control signal controlling the plurality of monochromatic light sources, the plurality of optical modulators and the scanner in accordance with the image signal,
wherein the control unit controls a pixel drive signal of the optical modulator such that a tilt of a monochromatic scanned image is compensated, the monochromatic scanned image being the modulated illumination light beams having been scanned on the display screen.

9. The multi-panel display apparatus of claim 8, wherein the scanner rotates unidirectionally.

10. The multi-panel display apparatus of claim 8, wherein the scanner rotates bidirectionally.

11. The multi-panel display apparatus of claim 8, wherein the scanning direction is left to right, and the control unit controls an uppermost pixel of the optical modulator to be first outputted and the output to be linearly delayed from an upper end to a lower end if the monochromatic scanned image is tilted clockwise, and the control unit controls a lowest pixel of the optical modulator to be first outputted and the output to be linearly delayed from the lower end to the upper end if the monochromatic scanned image is tilted counter-clockwise.

12. The multi-panel display apparatus of claim 11, wherein the output delay is determined in accordance with a degree of tilt of the monochromatic scanned image.

13. The multi-panel display apparatus of claim 8, wherein the scanning direction is right to left, and the control unit controls an uppermost pixel of the optical modulator to be first outputted and the output to be linearly delayed from an upper end to a lower end if the monochromatic scanned image is tilted counter-clockwise, and the control unit controls a lowest pixel of the optical modulator to be first outputted and the output to be linearly delayed from the lower end to the upper end if the monochromatic scanned image is tilted clockwise.

14. The multi-panel display apparatus of claim 13, wherein the output delay is determined in accordance with a degree of tilt of the monochromatic scanned image.

15. A method of compensating a beam tilt in a display apparatus in which an illumination light beam is scanned on a display screen, the illumination light beam being sequentially irradiated by a plurality of monochromatic light sources and being modulated by an optical modulator, the method comprising:
determining a degree of tilt of a monochromatic scanned image formed on the display screen; and
determining an outputting timing per pixel of the monochromatic scanned image based on the degree of tilt and a scanning direction of the monochromatic scanned image.

16. The method of claim 15, wherein, in the step of determining the outputting timing, the scanning direction is left to right, and an uppermost pixel of the optical modulator is controlled to be first outputted and the output is controlled to be linearly delayed from an upper end to a lower end if the monochromatic scanned image is tilted in clockwise, and a lowest pixel of the optical modulator is controlled to be first outputted and the output is controlled to be linearly delayed from the lower end to the upper end if the monochromatic scanned image is tilted counter-clockwise.

17. The method of claim 15, wherein, in the step of determining the outputting timing, the scanning direction is right to left, and an uppermost pixel of the optical modulator is controlled to be first outputted and the output is controlled to be linearly delayed from an upper end to a lower end if the monochromatic scanned image is tilted in the counter-clockwise direction, and a lowest pixel of the optical modulator is controlled to be first outputted and the output is controlled to be linearly delayed from the lower end to the upper end if the monochromatic scanned image is tilted in the clockwise direction.

18. A computer-readable recorded medium configured to record a program executable by a computer to execute a method of compensating a beam tilt in a display apparatus in which an illumination light beam is scanned on a display screen, the illumination light beam being sequentially irradiated by a plurality of monochromatic light sources and being modulated by an optical modulator, the program executing:
determining a degree of tilt of a monochromatic scanned image formed on the display screen; and
determining an outputting timing per pixel of the monochromatic scanned image based on the degree of tile and a scanning direction of the monochromatic scanned image.
